(19) United States
(12) Patent Application Publication
(10) Pub. No.: US 2023/0384202 A1
(43) Pub. Date: Nov. 30, 2023

(54) DETECTION DEVICE AND DETECTION METHOD OF MEASURED SUBSTANCE

(71) Applicant: CITIZEN WATCH CO., LTD., Tokyo (JP)

(72) Inventors: Kana WADA, Tokyo (JP); Takaaki NOZAKI, Tokyo (JP); Hitomi URABE, Tokyo (JP)

(21) Appl. No.: 18/249,785

(22) PCT Filed: Oct. 21, 2021
(86) PCT No.: PCT/JP2021/039008

§ 371 Date: Apr. 20, 2023

(30) Foreign Application Priority Data
Oct. 23, 2020 (JP) 2020-178023

(51) Int. Cl. G01N 15/14; B01L 3/00

(52) U.S. Cl. CPC G01N 15/1404; G01N 15/1456; B01L 3/502761; G01N 2015/0065

(57) ABSTRACT

A detection device of a measured substance according to an embodiment of the present disclosure has as its object the simple detection of bacteria, fungi, and other biologically related substances. A detection device according to an embodiment of the present disclosure has a container containing a solution and composite particles made of a measured substance and a magnetic labeling substance bonded together, a magnetic field applying part provided with a plurality of magnets arranged at a position other than a lower position than the container so that pole faces of the same magnetic poles face each other separated by predetermined intervals and applying a magnetic field so as to collect the composite particles at a predetermined region where free-space light is incident other than the bottom region of the container, an imaging unit capturing composite particles collected at the predetermined region where free-space light is incident through a region between the pole faces of the same poles facing each other, and a detecting unit detecting the composite particles based on an image captured by the imaging unit.

### FIELD

The present invention relates to a detection device and detection method of a measured substance.

### BACKGROUND

Recently, the need for a method of detecting viruses, bacteria, fungi, or other biologically related substances present in a biospecimen solution has been rising. As the method for detecting viruses or other biologically related substances of a size of several hundred nm, an optical detection method using near field light is known (for example, PTL 1). Here, “near field light” is light which causes total reflectance at an interface if the incident angle is over a certain critical angle when proceeding from a medium with a high refractive index to a medium with a low refractive index and does not proceed through the substance with a low refractive index, but very slightly leaks out to an extent of one wavelength worth of the medium with a low refractive index. Near field light does not propagate through a space, so does not diffract. This is used as a means for obtaining information relating to a substance with a wavelength of light over the diffraction limit or less at the resolution of a microscope limited by the diffraction limit and is being closely looked at as a method for processing fine substances.

However, bacteria, fungi, and other biologically related substances have sizes of several micrometers, so with the optical detection method using near field light, there was the problem that bacteria, fungi, and other biologically related substances were difficult to detect.

### CITATIONS LIST

### Patent Literature

[PTL 1] WO2017/187744

### SUMMARY

A detection device of a measured substance according to an embodiment of the present disclosure has as its object the simple detection of bacteria, fungi, and other biologically related substances.

A detection device according to an embodiment of the present disclosure has a container containing a solution and composite particles made of a measured substance and a magnetic labeling substance bonded together, a magnetic field applying part provided with a plurality of magnets arranged at a position other than a lower position than the container so that pole faces of the same magnetic poles face each other separated by predetermined intervals and applying a magnetic field so as to collect the composite particles at a predetermined region where free-space light is incident other than the bottom region of the container, an imaging unit capturing composite particles collected at the predetermined region where free-space light is incident through a region between the pole faces of the same poles facing each other, and a detecting unit detecting the composite particles based on an image captured by the imaging unit.

In the detection device according to an embodiment of the present disclosure, preferably pole faces of opposite magnetic poles from the magnetic poles of the pole faces facing each other among the pole faces of the plurality of magnets are arranged at the outside from the peripheral walls of the container.

In the detection device according to an embodiment of the present disclosure, preferably at a plane parallel to the plurality of magnets, a position with the maximum magnetic field strength is included in the region captured by the imaging unit and at a position separated from a top end part of the container downward by a predetermined distance, there is a region with the magnetic field strength substantially constant close to the maximum value.

In the detection device according to an embodiment of the present disclosure, preferably the plurality of magnets have columnar shapes.

In the detection device according to an embodiment of the present disclosure, the plurality of magnets may have conical shapes or pyramidal shapes.

In the detection device according to an embodiment of the present disclosure, the plurality of magnets may have ring shapes.

In the detection device according to an embodiment of the present disclosure, preferably the facing poles of the plurality of magnets have tapered shapes partially cut away at parts at the imaging unit sides.

In the detection device according to an embodiment of the present disclosure, preferably a light transmissive member housing the plurality of magnets is further provided.

A detection method according to an embodiment of the present disclosure includes placing a solution and composite particles made of a measured substance and a magnetic labeling substance bonded together into a container, arranging a plurality of magnets arranged at a position other than a lower position than the container so that pole faces of the same magnetic poles face each other separated by predetermined intervals, applying a magnetic field so as to collect the composite particles at a predetermined region where free-space light is incident other than the bottom region of the container, capturing composite particles collected at the predetermined region where free-space light is incident through a region between the pole faces of the same poles facing each other, and detecting the composite particles based on the captured image.

In the detection method according to an embodiment of the present disclosure, preferably at a plane parallel to the plurality of magnets, a position with the maximum magnetic field strength is included in the captured region, and at a top surface of the solution, there is a region with the magnetic field strength substantially constant close to the maximum value.

According to a detection device of a measured substance according to an embodiment of the present disclosure, it is possible to more simply detect bacteria, fungi, and other biologically related substances compared with the case of using near field light.

### BRIEF DESCRIPTION OF DRAWINGS

FIG. 1 is a view of the configuration of a detection device of a measured substance according to a first embodiment of the present disclosure.

FIG. 2 is a side view of a container forming part of the detection device of a measured substance according to the first embodiment of the present disclosure.

FIG. 3 is a side view of a container forming part of the detection device of a measured substance according to the first embodiment of the present disclosure showing a state of placing a measured substance and a magnetic labeling substance into a solution and agitating them to promote a reaction.

FIG. 4 is an example of an image in a predetermined region of a solution captured by an imaging unit forming part of the detection device of a measured substance according to the first embodiment of the present disclosure.

FIG. 5 is a side view of a container forming part of the detection device of a measured substance according to the first embodiment of the present disclosure showing a state of placing a measured substance, a magnetic labeling substance, and a fluorescent labeling substance into a solution and agitating them to promote a reaction.

FIG. 6 is another example of an image in a predetermined region of a solution captured by an imaging unit forming part of the detection device of a measured substance according to the first embodiment of the present disclosure.

FIG. 7 is a view of the configuration of the detection device of a measured substance according to the first embodiment of the present disclosure showing a positional relationship between a magnetic field applying part and a container.

FIGS. 8A to 8C are plan views of a plurality of magnets used for the detection device of a measured substance according to the first embodiment of the present disclosure.

FIG. 9 is a view showing a distribution of a magnetic field formed by the plurality of magnets used for the detection device of a measured substance according to the first embodiment of the present disclosure.

FIG. 10 is a graph showing a relationship between a distribution of a strength of a magnetic field formed by the plurality of magnets used for the detection device of a measured substance according to the first embodiment of the present disclosure and a distance from the magnets.

FIG. 11 is a plan view showing a relationship between a region in which composite particles collected by the detection device of a measured substance according to the first embodiment of the present disclosure are distributed and positions of the plurality of magnets.

FIGS. 12A to 12C are plan views of a first modification of the plurality of magnets used for the detection device of a measured substance according to the first embodiment of the present disclosure.

FIGS. 13A 13B are plan views of a second modification of the plurality of magnets used for the detection device of a measured substance according to the first embodiment of the present disclosure.

FIG. 14 is a graph showing a relationship between a distribution of a strength of a magnetic field formed by the plurality of magnets of the second modification used for the detection device of a measured substance according to the first embodiment of the present disclosure and a distance from the magnets.

FIG. 15A is a cross-sectional view of the plurality of magnets used for the detection device of a measured substance according to the first embodiment of the present disclosure while 15B is a cross-sectional view of the plurality of magnets used for the detection device of a measured object according to a second embodiment of the present disclosure.

FIGS. 16A and 16B are views showing a plurality of magnets, transmissive member, and container used for the detection device of a measured substance according to a third embodiment of the present disclosure, where FIG. 16A is a plan view and FIG. 16B is a cross-sectional view.

FIGS. 17A and 17B are cross-sectional views of the plurality of magnets, transmissive member, and container used for the detection device of a measured substance according to the third embodiment of the present disclosure, where FIG. 17A is a cross-sectional view of a comparative example in the case assuming no transmissive member and FIG. 17B is a view of the case where there is a transmissive member.

FIG. 18 is a cross-sectional view of the plurality of magnets, transmissive member, and container used for the detection device of a measured substance according to the third embodiment of the present disclosure showing a modification of the container.

FIGS. 19A and 19B are cross-sectional views of modifications of the plurality of magnets, transmissive member, and container used for the detection device of a measured substance according to the third embodiment of the present disclosure, where FIG. 19A is a cross-sectional view of a comparative example in the case assuming no transmissive member and FIG. 19B is a view of the case where there is a transmissive member.

FIG. 20 is a view of the configuration of the detection device of a measured substance according to a fourth embodiment of the present disclosure.

### DESCRIPTION OF EMBODIMENTS

Below, referring to the drawings, a detection device and detection method of a measured substance according to embodiments of the present disclosure will be explained. However, it should be noted that the technical scope of the present invention is not limited to these embodiments and extends to inventions described in the claims and their equivalents.

### First Embodiment

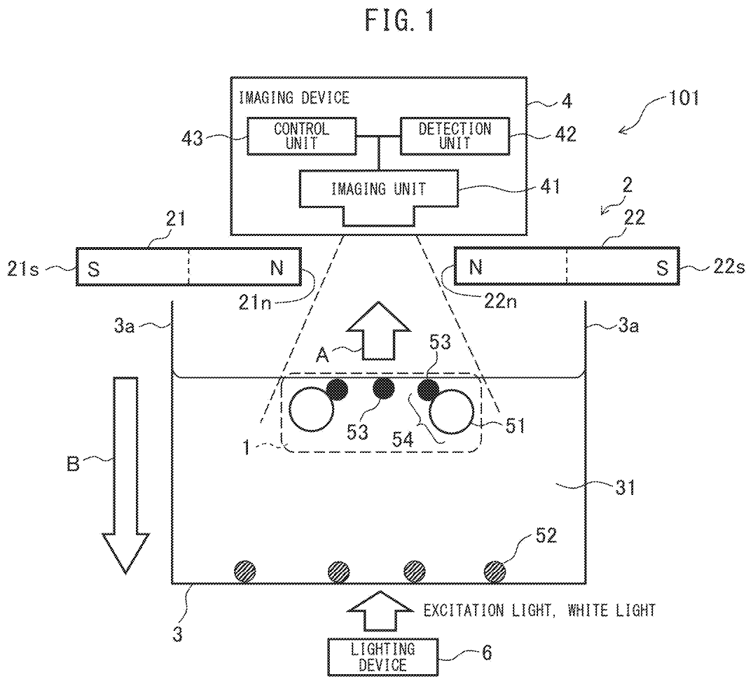

First, a detection device of a measured object according to a first embodiment of the present disclosure will be explained. FIG. 1 shows a view of the configuration of a detection device 101 of a measured object according to the first embodiment of the present disclosure. The detection device 101 of a measured substance according to the first embodiment has a container 3, magnetic field applying part 2, and imaging device 4.

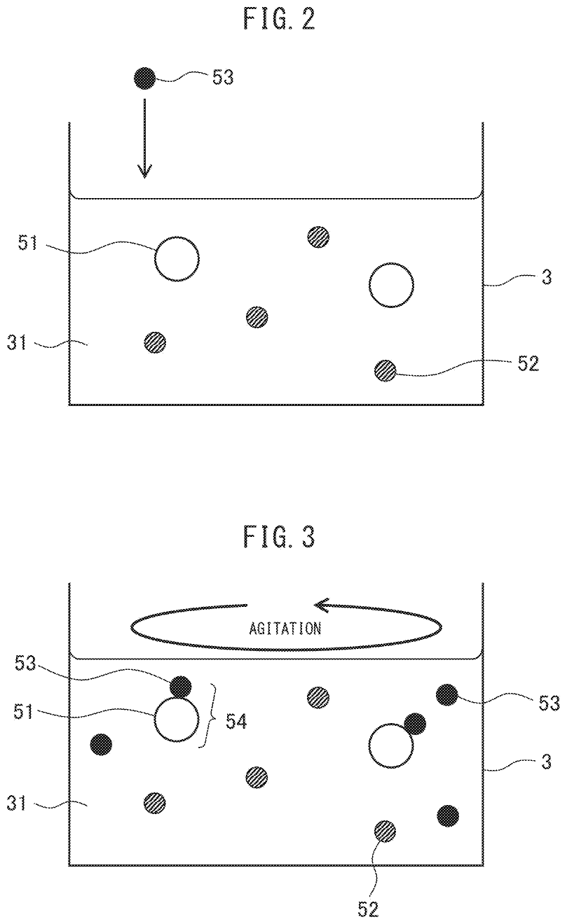

The container 3 contains a solution 31 and composite particles 54 comprised of a measured substance 51 and a magnetic labeling substance 53 bonded together. The container 3 is not a channel through which a fluid flows, but is something holding a fluid. As the solution 31, for example, a biospecimen solution is used. As an example of a biospecimen solution, for example, saliva, blood, urine, and sweat may be mentioned. FIG. 2 is a side view of the container 3 forming part of the detection device 101 of a measured substance according to the first embodiment of the present disclosure. FIG. 3 is a side view of the container 3 forming part of the detection device 101 of a measured substance according to the first embodiment of the present disclosure showing a state of placing a measured substance 51 and a magnetic labeling substance 53 into the solution 31 and agitating them to promote a reaction. Here, preferably the magnetic labeling substance 53 is bonded with all of the measured substance 51 in the solution 31 whereby the composite particles 54 are formed. Further, these substances need not be bonded at the point of time when the measured substance 51 and magnetic labeling substance 53 are placed in the container 3. That is, a reaction where the magnetic labeling substance 53 is bonded with the measured substance 51 may be promoted and the composite particles 54 may be formed due to the flow of the solution 31 generated due to agitation in the container 3 etc. As examples of the measured substance 51, Candida, Escherichia coli, and CRP (C reactive protein) may be mentioned.

As shown in FIG. 1, a predetermined region 1 is a region where the free-space light is incident other than the bottom region of the container 3. At the bottom region of the container 3, other substances 52 comprised of substances not corresponding to any of the measured substance 51, magnetic labeling substance 53, and composite particles 54 settle. The other substances 52 include foreign matter. The predetermined region 1 is preferably a region which does not include the other substances 52 other than the bottom region.

“Free-space light” (also referred to as “propagating light”) means general light propagated through space and does not include locally present light such as near field light. Specifically, “free-space light” is in general defined as light not including near field light exhibiting rapid attenuation at a position separated from the source of generation by exactly a distance from several hundred nanometers to several micrometers. In this Description as well, it means near field light is not included and means light not exhibiting rapid attenuation at a position separated from the interface of the container and solution by a distance of several hundred nanometers to within several micrometers. With the method utilizing near field light, the region where the measured substance can be detected is limited to a range of several hundred nanometers from the surface of the solution. The size of bacteria or fungi is on the order of several micrometers, so with near field light, detection is difficult. Furthermore, there was the problem that a detection device utilizing near field light was complicated in the detection board or optical system. As opposed to this, the detection device of a measured object according to an embodiment of the present disclosure uses free-space light, so observation of a substance of the wavelength of light or more is possible. If present at a predetermined region 1, there is no limit to the size of the measured substance 51. For this reason, according to the detection device of a measured object according to an embodiment of the present disclosure, it is possible to detect bacteria, fungi, etc. having a size on the order of several micrometers by a simple structure. The free-space light is emitted from a lighting device 6 arranged below the container 3 toward a predetermined region 1. However, the invention is not limited to such an example. The lighting device 6 may also be arranged on the side surface or the top surface of the container 3. Furthermore, the invention is not limited to a case using the lighting device 6, and may also utilize natural light as the free-space light.

As the method of agitation of the solution 31 at the container 3, it is possible to agitate it by shaking the container 3 by hand before setting it at the detection device 101 and possible to provide the detection device 101 with an agitation mechanism and agitate it inside the detection device 101. If provision at the detection device 101, the method of agitation by pushing the container 3 against a rotating disk like a vortex mixer and centrifugal agitation, ultrasonic shaking, etc. can be utilized. Furthermore, if emitting free-space light on the solution 31, the solution 31 is heated by the light emitted from the lighting device 6 (excitation light or white light) and the heating causes convection at the solution 31. Note that, if the imaging unit 41 captures the solution 31, the solution 31 does not necessarily have to be agitated.

The magnetic field applying part 2 is provided with a plurality of magnets (21, 22) arranged at a position other than the lower position than the container 3 (for example, a higher position than the container 3) so that the pole faces (21n, 22n) of the same magnetic poles (for example, N poles) face each other separated by predetermined intervals. Here, the state where the plurality of magnets “face” each other means the state where the plurality of magnets are oriented toward each other and the state where the same magnetic poles of the plurality of magnets face the center part. Therefore, this includes not only the state where the plurality of magnets are arranged symmetrically, but also the state where they are arranged asymmetrically. Furthermore, the plurality of magnets (21, 22) are preferably arranged on the same plane. For the magnets (21, 22), alnico magnets, iron-chromium-cobalt magnets, samarium-cobalt magnets, neodymium magnets, ferrite magnets, etc. can be used. Further, the magnetic field applying part 2 applies a magnetic field so as to collect the composite particles 54 at a predetermined region 1 on which free-space light incident forming a region other than the bottom region of the container 3.

If placing the magnetic field applying part 2 at the higher position than the container 3, the composite particles 54 forming the magnetically labeled measured substance and the unreacted magnetic labeling substance 53 are collected at the predetermined region 1 forming the detection region at the top part of the container 3. On the other hand, the other substances 52 settle at the bottom surface of the container 3 due to gravity. The composite particles 54 are collected at the predetermined region 1 of a region other than the bottom region of the container 3 because the other substances 52 settled at the bottom region of the container 3 become noise and sometimes make detection of the composite particles 54 difficult. According to the detection device 101 of a measured object according to the first embodiment, the predetermined region 1 at which the composite particles 54 are collected and the bottom region at which the other substances 52 settle can be separated. Here, at the posture of the detection device 101 at the time of use, the direction of gravity will be referred to as the “bottom” direction of the detection device while the direction opposite to the direction of gravity will be referred to as the “top” direction” of the detection device.

The imaging device 4 has an imaging unit 41, a detecting unit 42, and a control unit 43. Free-space light incident on the predetermined region 1 is reflected, scattered, etc. by the composite particles 54 in the solution 31 contained in the predetermined region 1 whereby it is incident on the imaging unit 41 of the imaging device 4 to form an image. The imaging unit 41 captures the composite particles 54 collected at the predetermined region 1 on which free-space light is incident through the region between the pole faces (21n, 22n) of the same poles facing each other. The magnetic field applying part 2 is arranged between the container 3 and the imaging unit 41. The imaging unit 41 can capture the composite particles 54 collected at the predetermined region 1 without being blocked by the magnetic field applying part 2, so it is possible to capture the composite particles 54 without making the magnetic field applying part 2 move. For this reason, it is possible to apply a magnetic field to the composite particles and capture the composite particles 54 while in the state with the composite particles collected at a predetermined region.

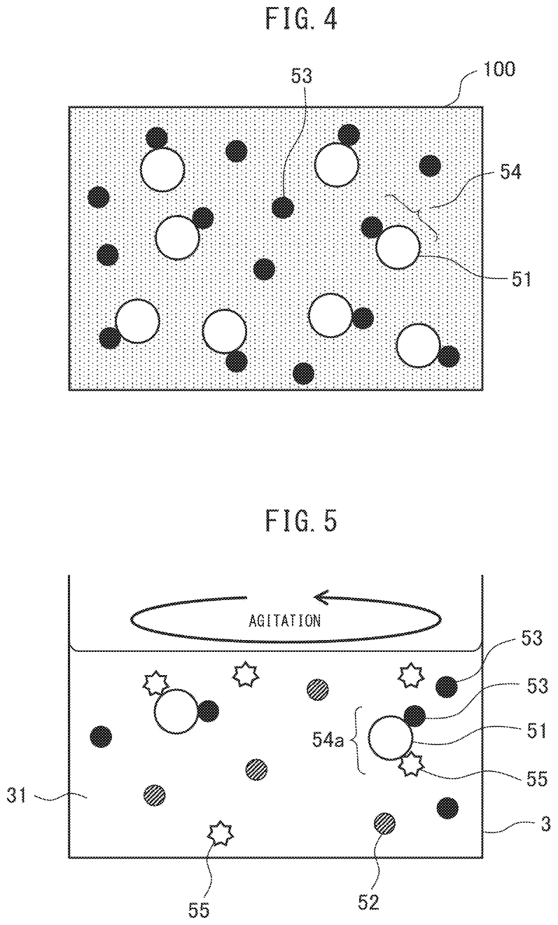

The imaging unit 41 has functions of capturing an object to acquire an image. As the imaging unit 41, for example, it is possible to use a still camera or video camera or other device capturing a still image or moving image. FIG. 4 shows an example of an image 100 at a predetermined region of the solution which the imaging unit 41 forming part of the detection device 101 of a measured object according to the first embodiment of the present disclosure captures.

The detecting unit 42 of the imaging device 4 detects the composite particles 54 based on the image 100 captured by the imaging unit 41. The detecting unit 42 detects the composite particles 54 from the image including the composite particles 54 and the unreacted magnetic labeling substance 53 collected at the predetermined region 1 forming the detection region. Specifically, the image of the magnetically labeled composite particles 54 collected at the top surface of the container 3 is analyzed for shapes, luminance, or magnetic field or movement due to convection. At the top surface of the solution 31, not only the composite particles 54, but also the unreacted magnetic labeling substance 53 is present, but discrimination is possible by the shape of the measured substance 51 and the bonding of the measured substance 51 and magnetic labeling substance 53.

The control unit 43 of the imaging device 4 controls the imaging device 4 as a whole. Further, the control unit 43 controls the units and devices other than the imaging device 4 included in the detection device 101 in accordance with need.

As the imaging device 4, for example, a computer provided with a CPU and memory etc. can be used. The memory may be a recording medium able to be read by a computer. The functions of the detecting unit 42 detecting composite particles 54 from the image 100 captured by the imaging unit 41 and the functions of the control unit 43 are performed by the CPU inside the imaging device 4 in accordance with programs stored in advance in the memory inside the imaging device 4. Note that the imaging unit 41, detecting unit 42, and control unit 43 do not necessarily have to be realized by a single computer etc. and may be realized by a plurality of computers etc.

The magnetic labeling substance 53 specifically bonds with the measured substance 51. The magnetic labeling substance 53 does not bond with the other substances 52. As shown in FIG. 1, the composite particles 54 are made of the measured substance 51 to which the magnetic labeling substance 53 are bonded, so are affected by the magnetic field applied by the magnetic field applying part 2 and move toward the direction of the arrow mark A. On the other hand, the other substances 52 do not include the magnetic labeling substance 53, so as shown by the arrow mark B, settle at the bottom region of the container 3 due to the gravity acting in the downward direction of the container 3. Therefore, due to the magnetic field which the magnetic field applying part 2 applies, the composite particles 54 are collected at the predetermined region 1 other than the bottom region of the container 3. By free-space light being incident on this predetermined region 1 and the reflected light, transmitted light, scattered light, etc. from the predetermined region 1 being captured by the imaging unit 41, it is possible to obtain an image including the composite particles 54.

Furthermore, if performing the labeling together with a fluorescent labeling substance or other substance having an optical property, it is possible to improve an S/N ratio. FIG. 5 is a side view of the container 3 forming part of the detection device 101 of a measured substance according to the first embodiment of the present disclosure showing the state where the measured substance 51, magnetic labeling substance 53, and fluorescent labeling substance 55 are placed in the solution 31 and agitated to promote a reaction. If the fluorescent labeling substance 55 has the property of specifically bonding with the measured substance 51, by agitating the solution 31 containing the measured substance 51, magnetic labeling substance 53, and the fluorescent labeling substance 55, it is possible to form composite particles 54a comprised of the measured substance 51 to which the magnetic labeling substance 53 and the fluorescent labeling substance 55 are bonded.

This solution 31, as shown in FIG. 1, can be subjected to a magnetic field by arranging the magnetic field applying part 2 at a position other than the lower position than the container 3, and the composite particles 54a (not shown) can be collected at the predetermined region 1 other than the bottom region of the container 3. On the other hand, the other substances 52 settle due to gravity and are collected at the bottom region of the container 3.

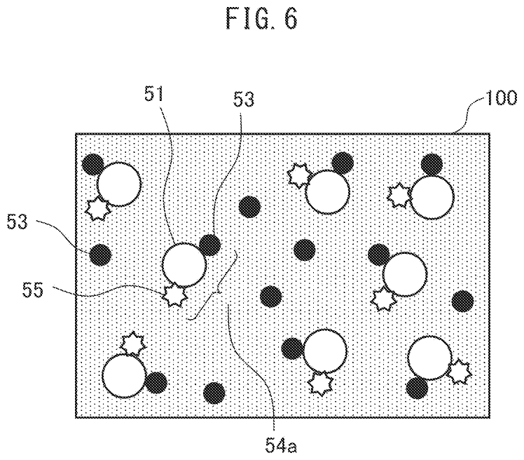

FIG. 6 shows another example of an image in the predetermined region 1 which the imaging unit 41 forming part of the detection device 101 of a measured substance according to the first embodiment of the present disclosure captures. The image 100 in the predetermined region 1 which the imaging unit 41 captures includes an image of the composite particles 54a collected by the magnetic field applying part 2 and the magnetic labeling substance 53, but other substances 52 are not included. Further, the composite particles 54a include the fluorescent labeling substance 55, so by shining fluorescent light at the predetermined region 1, it is possible to easily observe the composite particles 54a.

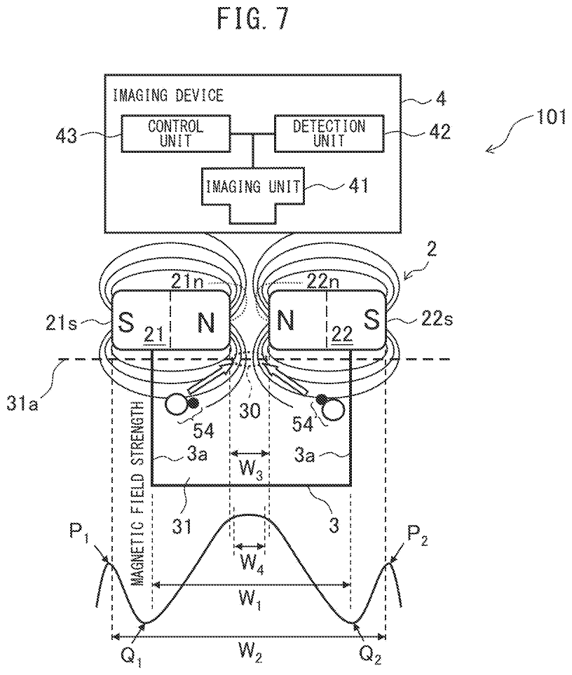

Next, the positional relationship between the magnetic field applying part and container in the detection device of a measured substance according to the first embodiment of the present disclosure will be explained. FIG. 7 is a view of the configuration of the detection device of a measured substance according to the first embodiment of the present disclosure showing the positional relationship between the magnetic field applying part and the container. FIG. 7 shows an example where the pole faces (21n, 22n) of the N poles of the two magnets (21, 22) are made to face each other. The magnetic field applying part 2 including the magnets (21, 22) is arranged between the container 3 and the imaging unit 41.

As shown in FIG. 7, a magnetic field is generated around the magnets (21, 22). The graph of the magnetic field strength shown at the bottom part of FIG. 7 shows the magnetic field strength at the position corresponding to the top surface 31a of the solution 31 in the container 3. As will be understood from the graph of magnetic field strength, the magnetic field strength becomes highest in the range shown by W₄. At the top surface 31a, the magnetic field strength becomes highest at the region 30 near the region sandwiched between the pole faces of the N poles (21n, 22n). For this reason, most of the composite particles 54 are collected at the region with the maximum magnetic field strength as shown by the arrow mark. Therefore, in FIG. 7, if the region shown by W₃ is defined as the imaging region, at a plane parallel to the plurality of magnets (21, 22), the position where the magnetic field strength becomes maximum is preferably included in the imaging region W₃ of the imaging unit 41.

However, the magnetic field strength becomes strong even near the pole faces (21s, 22s) of the magnetic poles (S poles) opposite to the magnetic poles (N poles) of the facing pole faces (21n, 22n). The magnetic field strengths have peaks (P₁, P₂), so the composite particles 54 are drawn to the S poles as well. If the composite particles 54 are drawn to near the S poles, they are blocked by the magnets (21, 22), so the imaging unit 41 is liable to no longer be able to capture the composite particles 54 drawn to near the S poles.

Therefore, in the detection device according to the present embodiment, preferably, among the pole faces (21n, 21s, 22n, 22s) of the plurality of magnets (21, 22), the pole faces (21s, 22s) of the magnetic poles (S poles) opposite to the magnetic poles (N poles) of the pole faces (21n, 22n) facing each other are arranged at the outside from the peripheral walls 3a of the container 3.

That is, when the width of the peripheral walls 3a of the container 3 is W₁ and the distance between the pole faces (21s, 22s) of the S poles of the two magnets (21, 22) is W₂, preferably the size of the peripheral walls 3a of the container 3 and the positions of the pole faces (21s, 22s) of the S poles of the magnets (21, 22) are set so that W₂ becomes larger than W₁.

By such a configuration, the composite particles 54 drawn to the S poles are blocked by the peripheral walls 3a of the container 3, and the composite particles 54 can be collected at only the region 30 where the imaging unit 41 is observed through the pole faces of the facing poles (21n, 22n), so the composite particles 54 can be efficiently detected.

Furthermore, the configuration is preferably one where the position with the minimum value of the magnetic field strength (Q₁, Q₂) formed by the magnets (21, 22) is the outside of the peripheral walls 3a of the container 3. If the magnetic field strength becomes the minimum value (Q₁, Q₂) at the inside of the peripheral walls 3a of the container 3, the magnetic field strength at the peripheral walls 3a becomes larger than the minimum value (Q₁, Q₂) and the state where the composite particles 54 are drawn to the S poles is liable to be maintained. If the position shown by the minimum value (Q₁, Q₂) becomes outside the peripheral walls 3a of the container 3, it is possible to keep the composite particles 54 from being drawn to the S pole side.

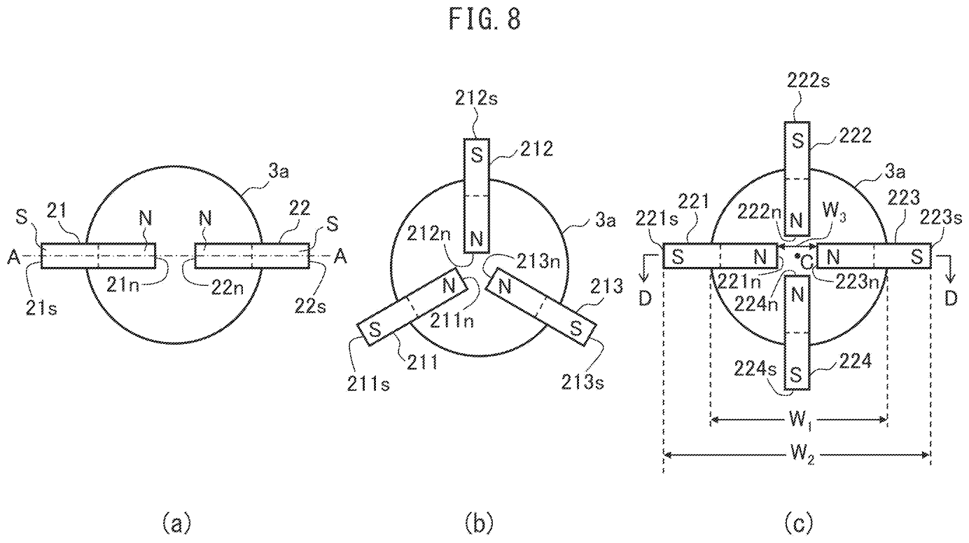

Next, the configuration of the plurality of magnets used for the detection device of a measured substance according to the first embodiment will be explained. The plurality of magnets are preferably columnar in shape. FIGS. 8A to 8C are plan views of the plurality of magnets used for the detection device of a measured substance according to the first embodiment of the present disclosure. These respectively show examples of use of two, three, and four block shaped magnets as the columnar magnets. FIGS. 8A to 8C also show the position of the peripheral walls 3a of the container. However, the invention is not limited to such an example. It is also possible to use cylindrical or prismatic shaped magnets as the columnar shaped magnets. As shown in FIG. 8A, if using two magnets, for example, it is preferable to arrange them so that the pole faces of the N poles (21n, 22n) of the magnets (21, 22) are made to face each other and the positions of the pole faces of the S poles (21s, 22s) are arranged outside of the peripheral walls 3a of the container. Further, the two magnets (21, 22) are preferably arranged on the same plane.

As shown in FIG. 8B, if using three magnets, for example, it is preferable to arrange them so that the pole faces of the N poles (211, 212n, 213n) of the magnets (211, 212, 213) are made to face each other and are arranged shifted 120 degrees and so that the positions of the pole faces of the S poles (211s, 212s, 213s) are arranged outside of the peripheral walls 3a of the container. Further, the three magnets (211, 212, 213) are preferably arranged on the same plane.

As shown in FIG. 8C, if using four magnets, for example, it is preferable to arrange them so that among the pole faces of the N poles (221n, 222n, 223n, 224n) of the magnets (221, 222, 223, 224), the pole faces (221n, 223n) are made to face each other and the pole faces (222n, 224n) are made to face each other and the magnets (221, 222, 223, 224) are arranged shifted 90 degrees and so the positions of the pole faces of the S poles (221s, 222s, 223s, 224s) are arranged outside of the peripheral walls 3a of the container. Further, the four magnets (221, 222, 223, 224) are preferably arranged on the same plane.

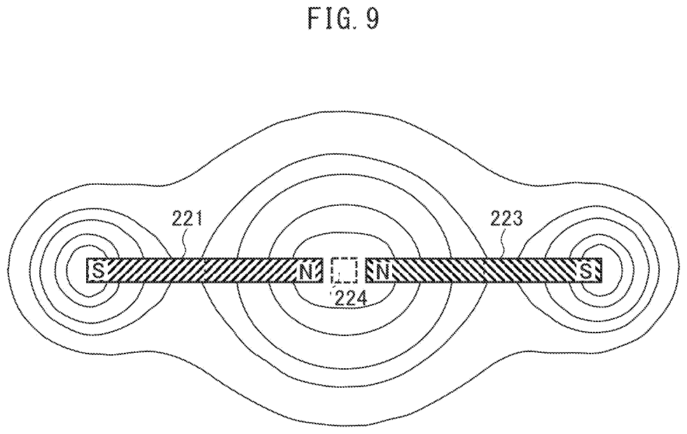

Next, the positional relationship between the region surrounded by the plurality of magnets and the region at which the composite particles are collected will be explained. FIG. 9 shows the distribution of the magnetic field formed by the plurality of magnets used for the detection device of a measured substance according to the first embodiment of the present disclosure. FIG. 9 shows the distribution of the magnetic field at the cross-section of the line D-D of FIG. 8C. It will be understood that a magnetic field with a uniform strength is formed near the pole faces of the N poles of the facing magnets (221, 223).

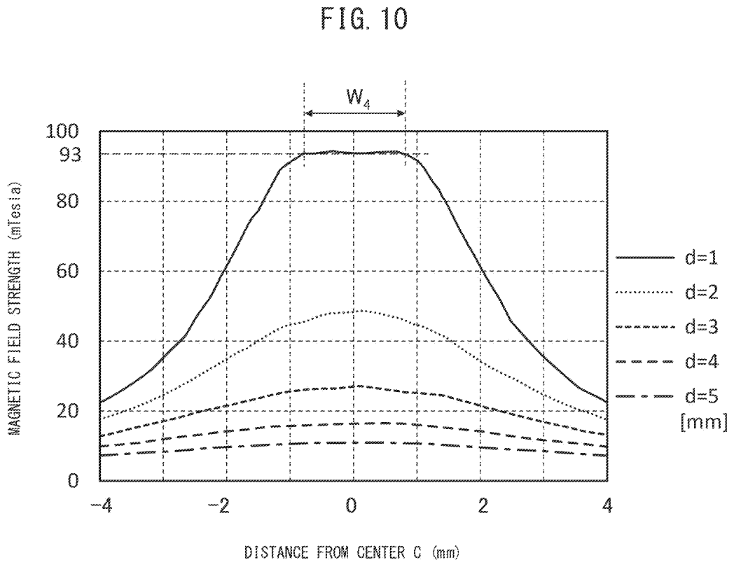

FIG. 10 shows the relationship between the distribution of the strength of the magnetic field formed by the plurality of magnets used for the detection device of a measured substance according to the first embodiment of the present disclosure and the distance from the magnets. FIG. 10 shows the distribution of the magnetic field at the cross-section of the line D-D of FIG. 8C and illustrates the distribution of the magnetic field strength at the distance “d” from the bottom surfaces of the four magnets (221 to 224). The distance between facing pole faces is 2 mm. In FIG. 10, the abscissa shows the distance (mm) from the position C of the center of the region surrounded by the magnets (221 to 224) while the ordinate shows the magnetic field strength (mTesla).

As shown in FIG. 10, it is learned that the when the distance “d” from the bottom surfaces of the magnets (221 to 224) is 1 mm, the region with the uniform magnetic field strength becomes the broadest. In the example shown in FIG. 10, the width W₄ of the region with the magnetic field strength of a predetermined strength, for example, 93 mTesla or more, is about 1.6 mm. From this, by setting the position of the top surface 31a of the solution 31 to become 1 mm from the bottom surfaces of the magnets (221 to 224), the region with the uniform magnetic field strength at the top surface 31a of the solution 31 becomes broadest and the composite particles can be uniformly distributed on the top surface 31a of the solution 31. Here, the top surface 31a of the solution 31 is arranged at a position separated from the top end part of the container 3 downward by a predetermined distance. In this way, it is preferable that there is a region with the magnetic field strength substantially constant close to the maximum value at a position separated from the top end part of the container 3 downward by a predetermined distance. If the magnetic field strength becomes higher at a specific position, the composite particles are densely collected and the number of the composite particles is liable to become difficult to accurately count from the captured image. According to the detection device according to an embodiment of the present disclosure, it is possible to make the composite particles be uniformly distributed on the top surface of the solution, so it is possible to accurately count the number of the composite particles. FIG. 10 shows the distribution of the magnetic field strength in the case where four magnets are arranged as shown in FIG. 8C. However, not limited to such an example, there are preferably three or more magnets so that the magnetic field is symmetrically formed about the center in the case of viewing the container from above.

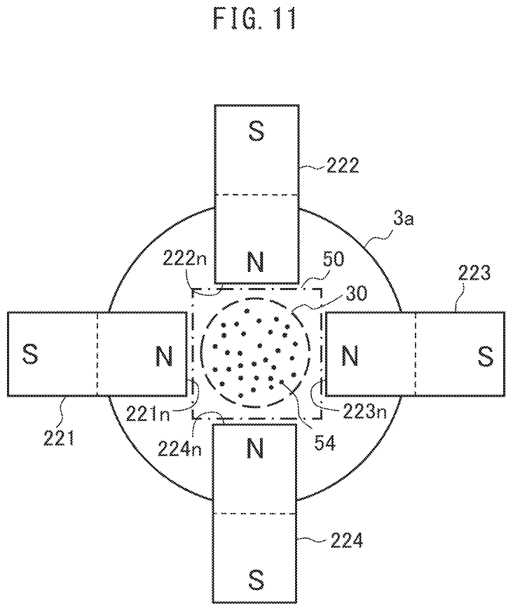

FIG. 11 show the positional relationship between the distribution of composite particles observed by the detection device of a measured substance according to the first embodiment of the present disclosure and the plurality of magnets. The composite particles 54 are drawn to the position with the strongest magnetic field strength. If the composite particles 54 are collected at the region 30 of FIG. 11 in accordance with the distribution of the magnetic field strength shown in FIG. 10, since the interval between the pole faces of the N poles (221n, 223n) of the facing magnets (221, 223) and the interval between the pole faces of the N poles (222n, 224n) of the facing magnets (222, 224) are both W₃ (=2 mm), the region 30 where the composite particles 54 are collected is included in the region 50 surrounded by the facing pole faces (221n, 222n, 223n, 224n). That is, the predetermined interval W₃ is broader than the width W₄ where the magnetic field strength formed by the plurality of magnets becomes a predetermined strength or more. By adopting such a configuration, the imaging unit can capture the composite particles 54 collected at the region 30 without being blocked by the magnets (221 to 224)

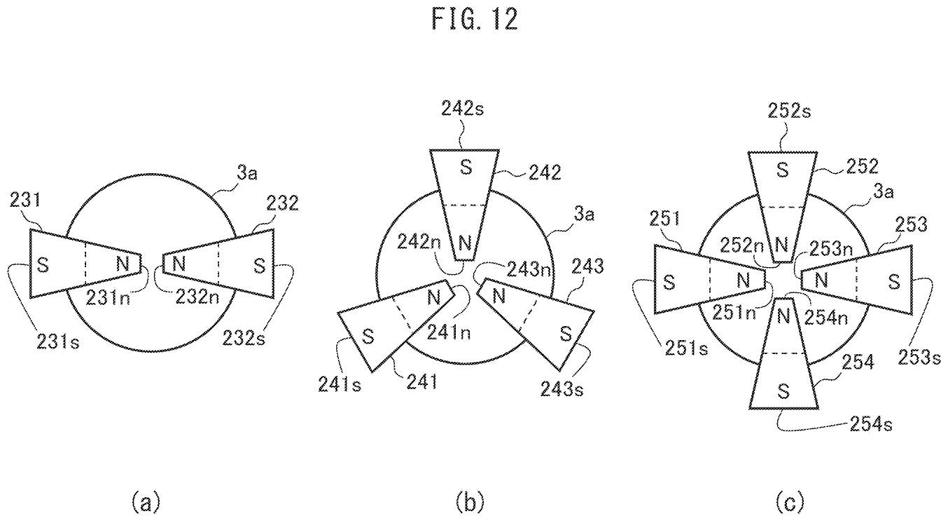

Next, a first modification of the detection device of a measured substance according to the first embodiment will be explained. FIGS. 12A to 12C are plan views of the first modification of the plurality of magnets used for the detection device of a measured substance according to the first embodiment of the present disclosure and respectively show examples of using two, three, and four magnets having conical shapes or pyramidal shapes. FIGS. 12A to 12C also show positions of the peripheral walls 3a of the container.

As shown in FIG. 12A, if using two magnets having conical shapes or pyramidal shapes, for example, it is preferable to arrange them so that the pole faces of the N poles (231n, 232n) of the magnets (231, 232) are made to face each other and so that the positions of the pole faces of the S poles (231s, 232s) are arranged outside of the peripheral walls 3a of the container. Further, the two magnets (231, 232) are preferably arranged on the same plane.

As shown in FIG. 12B, if using three magnets having conical shapes or pyramidal shapes, for example, it is preferable to arrange them so that the pole faces of the N poles (241n, 242n, 243n) of the magnets (241, 242, 243) are made to face each other and are arranged shifted 120 degrees and so that the positions of the pole faces of the S poles (241s, 242s, 243s) are arranged outside of the peripheral walls 3a of the container. Further, the three magnets (241, 242, 243) are preferably arranged on the same plane.

As shown in FIG. 12C, if using four magnets having conical shapes or pyramidal shapes, for example, it is preferable to arrange them so that among the pole faces of the N poles (251n, 252n, 253n, 254n) of the magnets (251, 252, 253, 254), the pole faces (251n, 253n) are made to face each other and the pole faces (252n, 254n) are made to face each other and the magnets (251, 252, 253, 254) are arranged shifted 90 degrees and so that the positions of the pole faces of the S poles (251s, 252s, 253s, 254s) are arranged outside of the peripheral walls 3a of the container. Further, the four magnets (251, 252, 253, 254) are preferably arranged on the same plane.

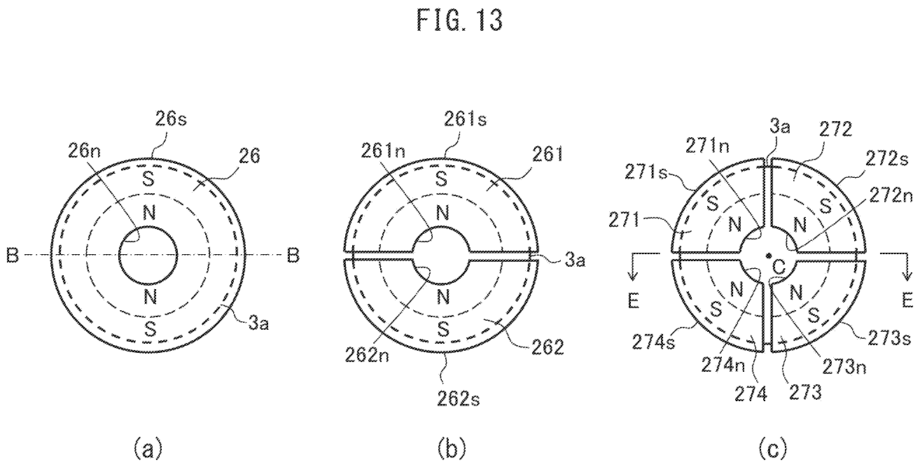

Next, a second modification of the detection device of a measured substance according to the first embodiment will be explained. FIGS. 13A to 13C are plan views of the second modification of the plurality of magnets used for the detection device of a measured substance according to the first embodiment of the present disclosure and respectively show examples of using one, two, or four magnets having ring shapes. FIGS. 13A to 13C also show positions of the peripheral walls 3a of the container.

As shown in FIG. 13A, if using one magnet having a ring shape with an inner peripheral surface and an outer peripheral surface magnetized to single magnetic poles, for example, it is preferable to arrange the pole face 26n of the N pole of the magnet 26 at the inside and arrange the outer peripheral surface forming the pole face 26s of the S pole at the outside from the peripheral walls 3a of the container. Alternatively, it is possible to arrange the pole face 26s of the S pole of the magnet 26 at the inside and arrange the outer peripheral surface forming the pole face 26n of the N pole at the outside from the peripheral walls 3a of the container. As shown in FIG. 13B, if using two magnets having ring shapes, for example, it is preferable to arrange them so that the pole faces of the N poles (261n, 262n) of the magnets (261, 262) face each other and the positions of the pole faces of the S poles (261s, 262s) are arranged at the outside of the peripheral walls 3a of the container. Further, the two magnets (261, 262) are preferably arranged on the same plane.

As shown in FIG. 13C, if using four magnets having ring shapes, for example, it is preferable to arrange the magnets (271, 272, 273, 274) so that, among the pole faces of the N poles (271n, 272n, 273n, 274n) of the magnets (271, 272, 273, 274), the pole faces (271n, 273n) are made to face each other, the pole faces (272n, 274n) are made to face each other, and the magnets are shifted by 90 degrees and so that the positions of the pole faces of the S poles (271s, 272s, 273s, 274s) are arranged outside of the peripheral walls 3a of the container. Further, the four magnets (271, 272, 273, 274) are preferably arranged on the same plane.

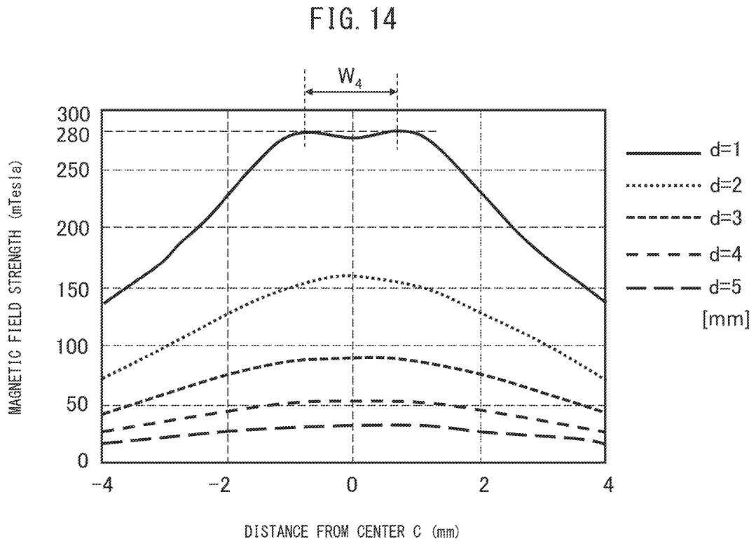

FIG. 14 shows the relationship between the distribution of the magnetic field strength formed by the plurality of magnets of the second modification used for the detection device of a measured substance according to the first embodiment of the present disclosure and the distance from the magnets. FIG. 14 shows the distribution of the magnetic field in the cross-section along the line E-E of FIG. 13C illustrating the distribution of the magnetic field strength at a distance “d” from the bottom surfaces of the magnets (271 to 274). The distances between the facing pole faces of the N poles (271n, 273n) and between the facing pole faces of the N poles (272n, 274n) are 2 mm. From FIG. 14, it will be understood that even if using four magnets having ring shapes, in the same way as the case of using block shaped magnets, when the distance “d” from the bottom surfaces of the magnets (271, 272, 273, 274) is 1 mm, the region where the magnetic field strength is uniform becomes broadest. In the example shown in FIG. 14, the width of the region W₄ where the magnetic field strength becomes a predetermined strength, for example, about 280 mTesla, is about 1.6 mm. Therefore, the region at which the composite particles are collected is included in the region surrounded by the facing pole faces (271n, 273n) and (272n, 274n). By using such a configuration, the imaging unit can capture the composite particles without being blocked by the magnets (271 to 274).

In the above way, according to the detection device of a measured substance according to the first embodiment, the magnetic field applying part 2 is used to collect the composite particles 54 at a predetermined region, then an image of the composite particles is captured through the region between the facing pole faces of the same poles, so it is possible to easily detect the measured substance.

### Second Embodiment

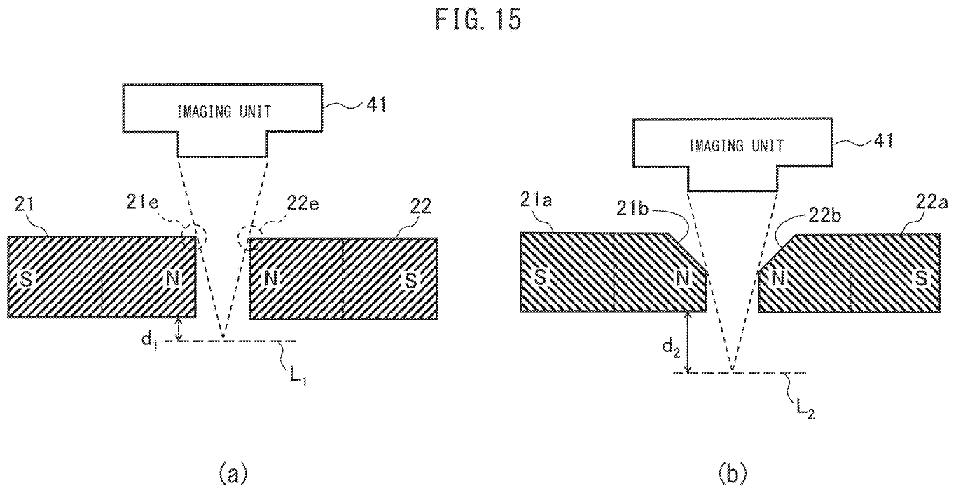

Next, a detection device of a measured substance according to a second embodiment of the present disclosure will be explained. FIG. 15A shows a cross-sectional view of the plurality of magnets used for the detection device of a measured object according to the first embodiment of the present disclosure. For example, FIG. 15A is a cross-sectional view along the line A-A in FIG. 8A. FIG. 15B shows a cross-sectional view of the plurality of magnets used for the detection device of a measured substance according to the second embodiment of the present disclosure. The point where the detection device of a measured substance according to the second embodiment differs from the detection device of a measured substance according to the first embodiment lies in the point that the facing poles of the plurality of magnets have tapered shapes with parts at the imaging unit sides cut away. The rest of the configuration in the detection device of a measured substance according to the second embodiment is similar to the configuration in the detection device of a measured substance according to the first embodiment, so a detailed explanation will be omitted.

As shown in FIG. 15A, in the first embodiment, if using block shaped magnets (21, 22) as the plurality of magnets, the corner parts (21e, 22e) of the magnets at the imaging unit 41 sides overlap the imaging region if bringing the imaging unit 41 close to the liquid level L₁ of the solution, and the position of the liquid level L₁ which the imaging unit 41 can capture is limited to the distance of d₁ from the bottom surface of the magnets (21, 22).

On the other hand, as shown in FIG. 15B, in the second embodiment, the facing poles of the magnets (21a, 22a) have tapered shapes with parts of the imaging unit 41 sides (21b, 22b) cut away. For this reason, parts of the imaging region of the imaging unit 41 are not blocked by the corner parts of the magnets and it is possible to lower the imaging region from L₁ to the position L₂ at the bottom surface side. In other words, if the distance between the magnets (21, 22) and the liquid level L₂ is defined as d₂, it is possible to make d₂ larger than d₁ (d₂>d₁).

In the above explanation, the case of using a plurality of magnets was explained as an example, but it is possible to form a tapered shape in the same way even if using the single magnet shown in FIG. 13A. For example, if the cross-sectional view shown in FIG. 15A is deemed a cross-sectional view along the line B-B of FIG. 13A, the inner peripheral side of the magnet 26 may also have a tapered shape with part of the imaging unit 41 side cut away.

In the above way, according to the detection device of a measured substance according to the second embodiment, it is possible to capture the solution at a deeper range. Furthermore, it is possible to prevent the outer peripheral parts of the imaging region from ending up becoming darker due to light being blocked at the corner parts (21e, 22e).

### Third Embodiment

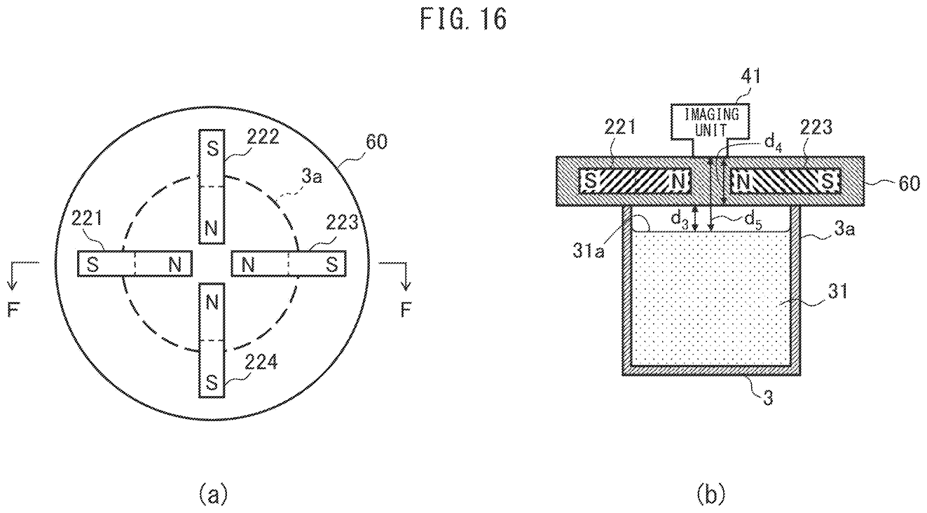

Next, a detection device of a measured substance according to a third embodiment of the present disclosure will be explained. FIGS. 16A and 16B are views of a plurality of magnets, transmissive member, and container used for the detection device of a measured substance according to the third embodiment of the present disclosure, where FIG. 16A is a plan view and FIG. 16B is a cross-sectional view along the line F-F of FIG. 16A. The point where the detection device of a measured substance according to the third embodiment differs from the detection device of a measured substance according to the first embodiment lies in the point that the magnetic field applying part further has a light transmissive member housing the plurality of magnets. The remainder of the configuration of the detection device of a measured substance according to the third embodiment is similar to that of the detection device of a measured substance according to the first embodiment, and thus a detailed explanation will be omitted.

As shown in FIG. 16A, the light transmissive member 60 can, for example, house four magnets (221 to 224). A magnetic field applying part containing the four magnets (221 to 224) is arranged between the container 3 and the imaging unit 41. If making the same magnetic poles of the plurality of magnets face each other, a repulsive force acts and the magnets try to move toward the outside from each other. The light transmissive member 60 can house the four magnets (221 to 224) and fix their respective positions. However, the number and shapes of the magnets which the light transmissive member 60 houses are not limited to such an example. The magnets may be shapes other than blocks and the number of magnets housed may be other than four. Plastic may be used for the light transmissive member 60. The light transmissive member 60 is light transmissive, so does not inhibit imaging by the imaging unit 41. In other words, nothing blocking imaging by the imaging unit 41 is arranged between the container 3 and the imaging unit 41.

Further, as shown in FIG. 16B, if arranging the imaging unit 41 to contact the light transmissive member 60, if the distance d₃ from the bottom surface of the light transmissive member 60 to the top surface 31a of the solution 31 is known, the thickness d₄ of the light transmissive member 60 can be used to adjust the distance d₅ (=d₃+d₄) from the imaging unit 41 to the top surface 31a of the solution 31

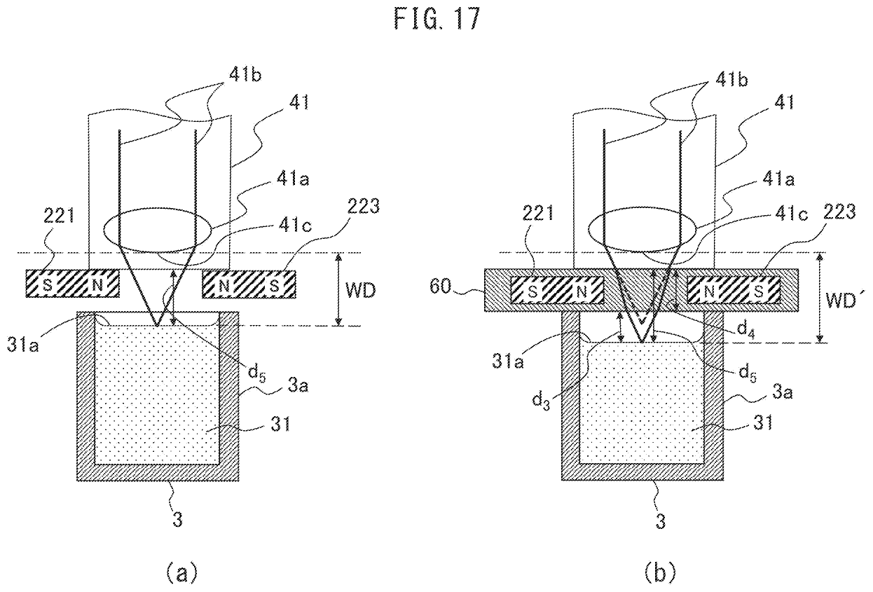

Next, the advantageous effect obtained by using the light transmissive member will be explained. FIG. 17B is a cross-sectional view of the plurality of magnets, transmissive member, and container used for the detection device of a measured substance according to the third embodiment of the present disclosure. FIG. 17A is a cross-sectional view of a comparative example in the case assuming there is no transmissive member. In FIGS. 17A and 17B, 41a shows an objective lens of the imaging unit 41, 41b shows a light beam, 41c shows a front end of the objective lens, and WD and WD′ show working distances. A “working distance” is the distance between the front end 41c of the objective lens used for the imaging unit 41 and the focal point. The magnetic field applying part including the magnets (221, 223) is arranged between the container 3 and the imaging unit 41.

For the light transmissive member 60, one having a refractive index “n” larger than 1 (for example, one having a refractive index “n” of 1.5) is used. Here, the case where there is a light transmissive member 60 (FIG. 17B) and the case where there is no light transmissive member 60 (FIG. 17A) will be compared. The working distance WD′ in the case where there is a light transmissive member 60 becomes longer than the working distance WD in the case where there is no light transmissive member 60. This is because if there is a light transmissive member 60, compared to if there is no light transmissive member 60, the optical path length at the light transmissive member 60 increases from about d₄ to d₄ Xn, so the working distance WD increases by exactly d₄ (n−1).

As shown in FIG. 17B, it is possible to extend the distance between the light transmissive member 60 and the top surface 31a of the solution 31 by the amount of this increase of the working distance and make it difficult for the liquid level to contact the light transmissive member 60. Further, it is also possible to utilize this amount of increase to make the thickness of the magnets greater by the amount of this increase of the working distance and strengthen the magnetic force.

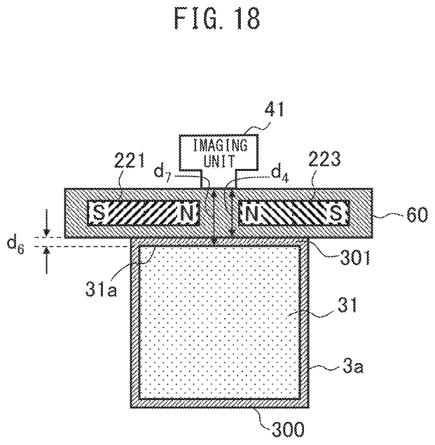

In the above detection device of a measured substance according to the third embodiment, the example where the container 3 was made an open type was shown, but the container may also be made a closed type. FIG. 18 shows a cross-sectional view of the plurality of magnets, transmissive member, and container used for the detection device of a measured substance according to the third embodiment of the present disclosure showing a modification of the container. The magnetic field applying part including the magnets (221, 223) is arranged between the container 300 and the imaging unit 41. The closed type container 300 does not allow entry of bubbles and can be filled with the solution 31. In this case, the top surface 31a of the solution 31 contacts the top lid 301 of the container 300. As shown in FIG. 18, if the imaging unit 41 is arranged to contact the light transmissive member 60, if designating the thickness of the top lid 301 by d₆, the thickness d₄ of the light transmissive member 60 can be used to adjust the distance d₇ (=d₄+d₆) from the imaging unit 41 to the top surface 31a of the solution 31.

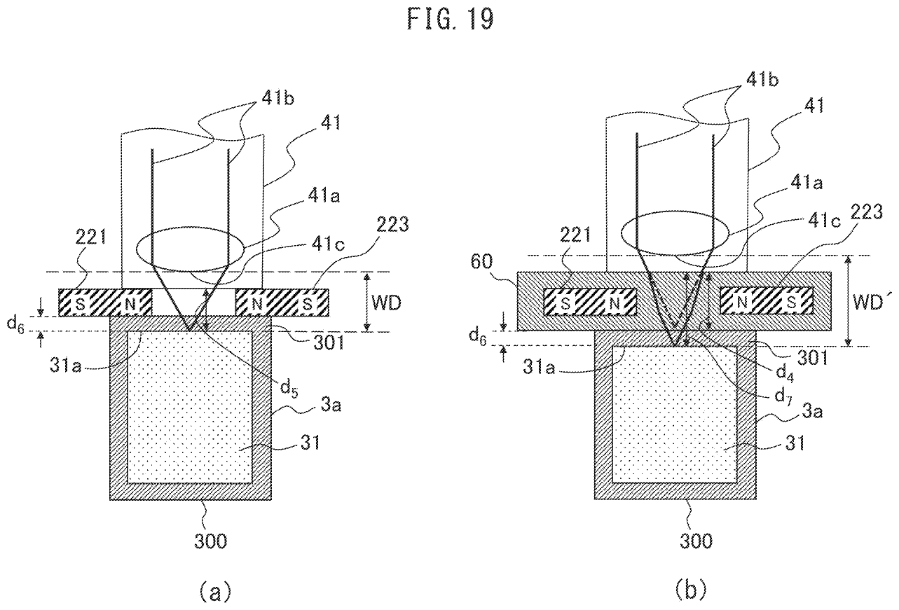

Next, the advantageous effect obtained by using the light transmissive member in the case of making the container a closed type will be explained. FIG. 19B is a cross-sectional view of the plurality of magnets, transmissive member, and container used for the detection device of a measured substance according to the third embodiment of the present disclosure. FIG. 19A is a cross-sectional view of a comparative example in the case assuming there is no transmissive member. The magnetic field applying part including the magnets (221, 223) is arranged between the container 300 and the imaging unit 41.

For the light transmissive member 60, one having a refractive index “n” larger than 1 (for example, one having a refractive index “n” of 1.5) is used. Here, the case where there is a light transmissive member 60 (FIG. 19B) and the case where there is no light transmissive member 60 (FIG. 19A) will be compared. The working distance WD′ in the case where there is a light transmissive member 60 becomes longer than the working distance WD in the case where there is no light transmissive member 60. This is because if there is a light transmissive member 60, compared to if there is no light transmissive member 60, the optical path length at the light transmissive member 60 increases from about d₄ to d₄ Xn, so the working distance WD increases by exactly d₄ (n−1).

As shown in FIG. 19B, it is possible to extend the distance between the light transmissive member 60 and the top surface 31a of the solution 31 by exactly the amount of this increase of the working distance and make it difficult for the liquid level to contact the light transmissive member 60. Further, it is also possible to utilize this amount of increase to make the thickness of the magnets greater by exactly the amount of this increase of the working distance and strengthen the magnetic force.

In the above way, according to the detection device of a measured substance according to the third embodiment, it is possible to easily fix the plurality of magnets.

### Fourth Embodiment

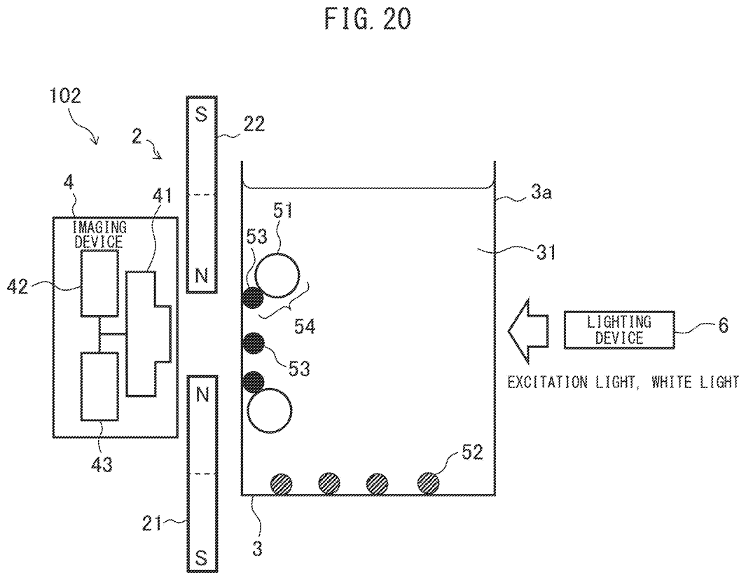

Next, a detection device of a measured substance according to a fourth embodiment of the present disclosure will be explained. FIG. 20 shows a view of the configuration of a detection device of a measured substance according to the fourth embodiment of the present disclosure.

The point where the detection device 102 of a measured substance according to the fourth embodiment differs from the detection device 101 of a measured substance according to the first embodiment lies in the point that the imaging device 4 and magnetic field applying part 2 are arranged at the side surface of the container 3. The magnetic field applying part 2 is arranged between the container 3 and the imaging unit 41. The remainder of the configuration of the detection device of a measured substance according to the fourth embodiment is similar to that the detection device of a measured substance according to the first embodiment, and thus a detailed explanation will be omitted.

As shown in FIG. 20, the other substances 52 not the measured object settle at the bottom surface of the container 3 due to gravity, but the composite particles 54 are collected at the side surface of the container 3 by the magnetic field applying part 2 and can be captured by the imaging unit 41.

According to the detection device of a measured substance according to a fourth embodiment, it is possible to fix the composite particles 54 at the side surface of the container 3, so it is possible to easily detect composite particles.

In the above explanation, the case where other substances not the measured object settled in the solution due to gravity was explained. However, even if the other substances move in the opposite direction to gravity in the solution, it is possible to utilize the detection device of the embodiment of the present disclosure. That is, it is also possible to set the magnetic field applying part at a bottom part of the container so as to make the measured substance bonding the magnetic labeling substance move in the opposite direction from the other substances. By arranging the magnetic field applying part at a suitable position in accordance with the mode of behavior of the other substances in the solution, it is possible to separate the positions of the other substances and measured substance in the solution.

Further, in the above embodiments, an example where the N poles of the plurality of magnets were made to face each other was shown, but the invention is not limited to such an example. The S poles may also be made to face each other.

In the above explanation, as the magnetic field applying part 2, the example of use of magnets was shown, but the invention is not limited to such an example. Electromagnets provided with iron cores and coils may also be used.

According to the detection device and detection method of a measured substance according to the embodiments of the present disclosure explained above, it is possible to detect bacteria, fungi, etc. of a size of several micrometers in a solution.

1. A detection device comprising:
a container containing a solution and composite particles made of a measured substance and a magnetic labeling substance bonded together;
a plurality of magnets arranged at a position other than a lower position than the container so that pole faces of the same magnetic pole face each other separated by predetermined intervals and applying a magnetic field so as to collect the composite particles at a predetermined region where free-space light is incident other than the bottom region of the container;
an imaging device capturing the composite particles collected at the predetermined region through a region between the pole faces of the same magnetic pole facing each other; and
a processor configured to detect the composite particles based on an image captured by the imaging unit.

2. The detection device according to claim 1, wherein the plurality of magnets are arranged at a higher position than the container.

3. The detection device according to claim 1, wherein pole faces of opposite magnetic pole from the magnetic pole of the pole faces facing each other among the pole faces of the plurality of magnets are arranged at the outside from peripheral walls of the container.

4. The detection device according to claim 1, wherein
at a plane parallel to the plurality of magnets, a position with the maximum magnetic field strength is included in the region captured by the imaging unit device, and
at a position separated from a top end part of the container downward by a predetermined distance, there is a region with the magnetic field strength substantially constant close to the maximum value.

5. The detection device according to claim 1, wherein the plurality of magnets have columnar shapes respectively.

6. The detection device according to claim 1, wherein the plurality of magnets have conical shapes or pyramidal shapes respectively.

7. The detection device according to claim 1, wherein the plurality of magnets have ring shapes respectively.

8. The detection device according to claim 1, wherein the facing poles of the plurality of magnets have tapered shapes partially cut away at parts at the imaging device sides respectively.

9. The detection device according to claim 1, further comprising a light transmissive member housing the plurality of magnets.

10. (canceled)

11. (canceled)

12. (canceled)

13. A detection method comprising;
placing a solution and composite particles made of a measured substance and a magnetic labeling substance bonded together into a container;
arranging a plurality of magnets arranged at a position other than a lower position than the container so that pole faces of the same magnetic pole face each other separated by predetermined intervals;
applying a magnetic field so as to collect the composite particles at a predetermined region where free-space light is incident other than the bottom region of the container;
capturing composite particles collected at the predetermined region through a region between the pole faces of the same magnetic pole facing each other; and
detecting the composite particles based on an image captured.

14. The detection method according to claim 13, wherein
at a plane parallel to the plurality of magnets, a position with the maximum magnetic field strength is included in the captured region and
at a top surface of the solution, there is a region with the magnetic field strength substantially constant close to the maximum value.

15. A detection device comprising:
a container containing a solution and composite particles made of a measured substance and a magnetic labeling substance bonded together;
a single magnet arranged at a position other than a lower position than the container, having a ring shape with an inner peripheral surface and an outer peripheral surface magnetized to mutually different single magnetic poles, and applying a magnetic field so as to collect the composite particles at a predetermined region where free-space light is incident other than the bottom region of the container;
an imaging device capturing the composite particles collected at the predetermined region through a region surrounded by the inner peripheral surface; and
a processor configured to detect the composite particles based on an image captured by the imaging device.

16. The detection device according to claim 15, wherein the outer peripheral surface is arranged at the outside from peripheral walls of the container.

17. The detection device according to claim 15, wherein the inner peripheral side of the magnet has tapered shapes partially cut away at parts at the imaging device sides.
